(19) United States
(12) Patent Application Publication
(10) Pub. No.: US 2007/0031109 A1
(43) Pub. Date: Feb. 8, 2007

(54) Content management system and content management method

(76) Inventors: Sougo Tsuboi, Kawasaki-shi (JP); Hideki Tsutsui, Kawasaki-shi (JP); Masaru Suzuki, Kawasaki-shi (JP); Koji Yamamoto, Yokohama-shi (JP); Yoshihiro Ohmori, Kawasaki-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/378,327

(22) Filed: Mar. 20, 2006

(30) Foreign Application Priority Data
Aug. 4, 2005 (JP) 2005-226759

(51) Int. Cl. H04N 5/91

(52) U.S. Cl. 386/46

(57) ABSTRACT

A content management system for managing contents including at least one of a video image and an audio, which are received from a network or a broadcast including a wired or wireless connection and are stored in a storage device for storing the received contents in association with content information, includes a human relationship table which records information relating to a plurality of entries utilizing the content management system, an entry searching section which searches one of entries as a query destination of an evaluation relevant to designated contents stored in the storage device, using the human relationship table, a content evaluation information acquisition section which acquires evaluation information from the query destination with respect to the designated contents, and a content reduction section which determines a method of reducing the designated contents based on the evaluation information.

### CROSS-REFERENCE TO RELATED APPLICATIONS

This application is based upon and claims the benefit of priority from prior Japanese Patent Application No. 2005-226759, filed Aug. 4, 2005, the entire contents of which are incorporated herein by reference.

### BACKGROUND OF THE INVENTION

1. Field of the Invention

The present invention relates to a content management system which is connected to a network and manages contents, which change with an elapse of time, for example, a video image or an audio, being acquired or recorded inside or outside of the network, and a content management method. In addition, the present invention relates to a technique of disabling deletion of a program or contents which might become a topic in the future and be recommended to be viewed.

2. Description of the Related Art

In viewing a television program or listening to a radio program, and further, in a streaming video image and audio broadcast streamed over a network, is becomes possible to achieve multi-channel and long-time image recording with the advancement of hardware.

However, it is impossible to view and listen everything because the time that a user can afford for viewing does not change. In addition, it is realistically difficult to continue to record programs infinitely while maintaining a high quality. Thus, there is a need for reducing contents which are not viewed yet or contents which have been viewed, but cannot be clearly determined to be kept. (In the present specification, the word “reduction” used here basically denotes a deletion (erasing) process or a compression process of contents.) The value of contents often changes over time, like a case in which one does not have an interest in contents, but she/he changes his/her mind to view the contents because of recommendation from friends. Thus, it is difficult to obtain precision relevant to their value.

In addition, one of the ways to enjoy contents in the future can include: utilizing meta data, namely, information on who is acting from one portion to another portion of contents or on which manufacturer's CM it is, thereby connecting a plurality of scenes in which a specific actor is acting, and further, carrying out a specific transition (screen processing or audio processing such as fadeout), thereby finishing one item of contents (work) (Hereinafter, such a work is referred to as “processed contents”.) It is predicted that a pleasure becomes doubled by sharing such a work among a plurality of persons. However, if image recording contents themselves are made open to public or are handed over to another person, there are many cases in which a problem occurs regarding current copyright. Therefore, there is a need for disclosing such edit information and using the individually recorded contents themselves, thereby reconstructing the processed contents. In order to enjoy such a work, as many contents as possible, which might be used in the processed contents, must be kept.

There are basically two techniques of reducing image recording contents, i.e., a manual erasure by user and automatic erasure, in which contents are erased sequentially after an elapse of a predetermined period of time after image recording. Variations include marking of contents by user in advance to keep those contents or changing a priority depending on the user's preference, genre and the like.

In Jpn. Pat. Appln. KOKAI Publication No. 2002-44584, there is described a technique of carrying out scheduling so as to execute deletion after it has been determined that the user does not have interest in the contents, in the case where the contents are not viewed, although they have been introduced a predetermined time or more in recommended contents for the user to view.

In addition, a variety of methods for eliminating valueless contents at a time point of image recording are known. A typical example is service analogous to recommendation of image recording contents. They also include: a general program information recommendation web site; an E-male magazine; and recommending an image recording target based on the user's preference or general evaluation information on contents.

In Jpn. Pat. Appln. KOKAI Publication No. 2003-235010, the following technique is described. This technique has a function of carrying out content screening utilizing others' information at a time point of image recording, wherein the user is recommended to acquire (store) the contents by using a popularity that a content distributor has counted in advance. Here, the others' information is acquired via a network. In addition, the contents are preferentially deleted from those that can be easily acquired again, for example, those that can be acquired again via a network, for example. This technique has already gained a certain appreciation, and is targeted for network-distributed contents. Therefore, it is difficult to apply the technique to contents whose evaluation information does not exist or contents which are difficult to acquire again.

However, the value of a program is not always determined depending on individual preference, and it is impossible to predict in advance a program which one's friend is to be interested in. In addition, the value is not determined at a time point of image recording, and is unknown in most cases. Evaluation information provided by a distributor provides or generally provided evaluation information does not always coincide with that of a group to which a user belongs to or that of a person trusted by a user. As a result, there occurs a problem that a program recommended afterwards has already been deleted and cannot be viewed.

### BRIEF SUMMARY OF THE INVENTION

It is an object of the present invention to provide a technique of properly determining contents to be reduced in a case where a large amount of contents is continuously recorded. It is another object of the present invention to provide a content management system and a content management method which achieves disabling deletion of contents which might become a topic and be recommended for viewing, the contents being required for reconfiguration of the disclosed processed contents.

According to the present invention, before deletion, evaluation of contents is queried to a device of another user close to one user in distance so as to determine the propriety of deletion (reduction) according to a result of the query.

The computation of evaluation of contents is primarily carried out by using:

1) Explicit evaluation (such as assigning non-deletion mark);

2) Viewing count (whole program or scene-by-scene (one portion in the whole program)); 3) Edit information (such as chapter division for CM cut or play list creation); and

4) Communication log information (such as E-mail, bulletin board, chat log).

Here, it is presumed that communication log information be highly evaluated if there is a topic relating to the program.

In addition, the calculation of a distance from another user is carried out based on:

a party (friend) explicitly specified by a user;

a party (friend of one's friend) further specified by the above specified user; and

community in which one participates.

In addition, with respect to a reduction method, according to the contents of evaluation and occupancy of a storage region at that time, any one of the following processing operations is executed.

Whole deletion

Partial deletion

Partial re-compression

More specifically, according to one aspect of the present invention, there is provided a content management system for managing contents including at least one of a video image and an audio, which are received from a network or a broadcast including a wired or wireless connection and are stored in a storage device for storing the received contents in association with content information, comprising: a human relationship table which records information relating to a plurality of entries utilizing the content management system; entry searching means for searching one of the plurality of entries as a query destination of an evaluation relevant to designated contents stored in the storage device, using the human relationship table; content evaluation information acquisition means for acquiring evaluation information from the query destination with respect to the designated contents; and content reduction means for determining a method of reducing the designated contents based on the evaluation information.

### BRIEF DESCRIPTION OF THE SEVERAL VIEWS OF THE DRAWING

FIG. 1 is a diagram showing a schematic configuration (first configuration) of a content information recording system according to an embodiment of the present invention;

FIG. 2 is a diagram showing an example in the case where only partial functional constituent elements are provided from among the configuration shown in FIG. 1, the example showing a system which is configured by sampling a content reduction portion (second configuration);

FIG. 3 is a diagram showing another example in the case where only partial functional constituent elements are provided from among the configuration shown in FIG. 1, the example showing a system which is configured by sampling a content evaluating portion (third configuration);

FIG. 4 is a diagram showing another example in the case where only partial functional constituent elements are provided from among the configuration shown in FIG. 1, the example showing a system which is configured by further functionally limiting the content evaluation portion (fourth configuration);

FIG. 5 is a diagram showing other examples of configurations (fifth and sixth configurations) in the case where only partial functional constituent elements are provided from among the configuration shown in FIG. 1;

FIG. 6 is a diagram showing a whole configuration in which the first to sixth configurations have been connected via a network;

FIG. 7A and FIG. 7B are views showing an example of a data structure of content recording information to be recorded in a content recording section;

FIG. 8A and FIG. 8B are views showing an example of a data structure of human relationship information recorded in a human relationship recording section;

FIG. 9A and FIG. 9B are views showing an example of a data structure of viewing information on contents recorded in a viewing information recording section;

FIG. 10A and FIG. 10B are views showing an example of a data structure of evaluation information on contents recorded in a manual evaluation information recording section;

FIG. 11 is a view showing an example of a data structure of edit information on contents recorded in an edit information recording section;

FIG. 12A and FIG. 12B are views showing an example of a data structure of edit information on contents recorded in an edit information recording section, in particular, registration information on “processed contents” obtained by connecting portions of a variety of contents to form one item of contents;

FIG. 13A, FIG. 13B and FIG. 13C are views showing an example of a data structure of a communication log recorded in a communication log recording section, namely, conversation information;

FIG. 14 is a flow chart showing an example of an outline of a content reduction processing operation;

FIG. 15 shows an example of a basic flow chart of content evaluations;

FIG. 16 is a view showing an example of data on an evaluation result;

FIG. 17 is a flow chart showing an example of a reduction method which a content reduction section carries out upon receiving an evaluation value;

FIG. 18A, FIG. 18B, and FIG. 18C are views showing an example of a method of computing an evaluation value for each interval at which an adding weight has been changed in accordance with a human relationship;

FIG. 19 shows an example of flow of processing operation for analyzing a communication log acquired from a communication log acquisition section, and then, acquiring an evaluation value of target contents; and

FIG. 20 shows an example of an information display screen when a user has provided an access to information in the content reduction section.

### DETAILED DESCRIPTION OF THE INVENTION

Hereinafter, preferred embodiments of the present invention will be described with reference to the accompanying drawings.

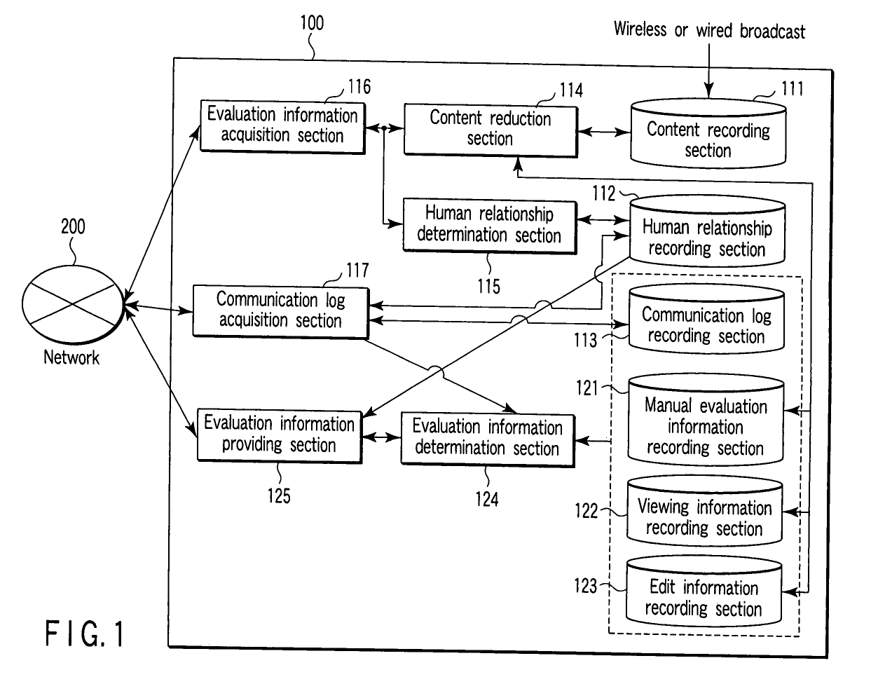

FIG. 1 is a diagram showing a schematic configuration of a content information recording system according to an embodiment of the present invention. A configuration according to FIG. 1 includes all of the constituent elements required for the present invention. This configuration is referred to as a first configuration 100. In addition, the following description presumes provision of communication means, although not shown, for making communication with another content information recording system described below, referring to a network 200. A variety of applicable communication means include: a physical network such as Internet irrespective of wired or wireless means; inter-process communication of OS represented by UNIX (R); and a logical network virtually constructed on a same computer by using an OS virtualization technique.

In the first configuration 100, a content recording section 111 records contents which can be distributed or acquired by wired or wireless means. The term “contents” used in the present invention denotes contents having change information with an elapse of time such as a video image or an audio. A method or system for recording contents is not described here because it is not a subject of the present invention.

A human relationship recording section 112 records a relationship between a user and a user of another apparatus described later in detail. It is necessary that information on the user of another apparatus includes direct or indirect means for providing an access to such another apparatus. For example, in the case where communication means is the Internet, an IP address, a domain name (FQDN), or an E-mail address possessed by such another apparatus is required information. Although an E-mail address is not information for directly providing an access to such another apparatus, information is transmitted in accordance with a simple mail transfer protocol (SMTP) by using the E-mail address, thereby making it possible to transmit the information to such another apparatus. In addition, the human relationship recording section 112 can record information other than information on the user of another apparatus, or the information relating to a site at which people having the same interest called a network community get together and make communication with each other. Means for providing an access to the network community specifies an E-mail address which functions as a mailing list; URL of a bulletin board (BBS) on Web; a channel name of Instant Messenger (IM), Internet Relay Chat (IRC) and the like.

A communication log recording section 113 records a communication log between a user and another person (not limited to an apparatus user), namely, a statement log such as E-mail or chat and Instant Messenger. In certain embodiments, a bulletin board system (BBS) may be provided on each apparatus so that there may be provided a configuration such that the associated log is recorded. Further, a log may be acquired and stored from a communication log record section of another apparatus via a communication log acquisition section 117.

A content reduction section 114 allocates a predetermined amount of a storage region in the content recording section 111 for a predetermined period of time. Specifically, the content reduction section 114 acquires evaluation information from an evaluation information acquisition section 116 with respect to each of the contents recorded in the content recording section 111. Then, the content reduction section 114 determines a method of reducing contents according to the acquired information, and executes reduction of the contents. In addition, the contents are fed back to a manual evaluation information recording section 121 or an edit information recording section 123 in accordance with a result of the execution.

A human relationship determination section 115 determines an entry which is appropriate as a destination of querying evaluation of target contents based on information on a user, another person, or network community recorded in the human relationship recording section 112.

The evaluation information acquisition section 116 queries evaluation information on the contents queried from the content reduction section 114 to an entry destination returned from the human relationship determination section 115, and returns a result of evaluation to the content reduction section 114.

The communication log acquisition section 117 returns the contents of the communication log recording section 113 in response to the query from the evaluation information acquisition section 116. At this time, access control using a record of the human relationship recording section 112 can be made. For example, control can be made such that no log is disclosed to a user to whom human relationship does not exist or the contents obtained by masking privacy information are returned.

A manual evaluation information recording section 121 records evaluation information explicitly provided to respective contents by a user, for example, information such as “five-stage evaluation”, “keep”, “delete” and “add to bookmark”) with respect to one item of contents. A generally known method is used as a method of registering a user in the manual evaluation information recording section 121, and therefore is not described in this specification.

A viewing information recording section 122 records information relating to whether or not a user can view respective contents, and more preferably, information relating to frequency.

An edit information recording section 123 records an edit operation which a user has made with respect to the respective contents. Scene division relevant to contents, whole deletion, partial deletion, commenting and the like is also recorded in the edit information recording section 123.

An evaluation information determination section 124 computes an evaluation value relating to specified contents from the contents of the manual evaluation information recording section 121, the viewing information recording section 122, or the edit information recording section 123, and more preferably, from the contents of the communication log recording section 113.

An evaluation information providing section 125 acquires evaluation information on target contents from the evaluation information determination section 124 in response to a query of content evaluation information from the evaluation information acquisition section 115 which is provided on a local apparatus or an external apparatus, and returns an evaluation value. At this time, access control using a record of the human relationship recording section 112 can be made. In this case, for example, it is possible to return evaluation information to only a query of a user to whom human relationship exists.

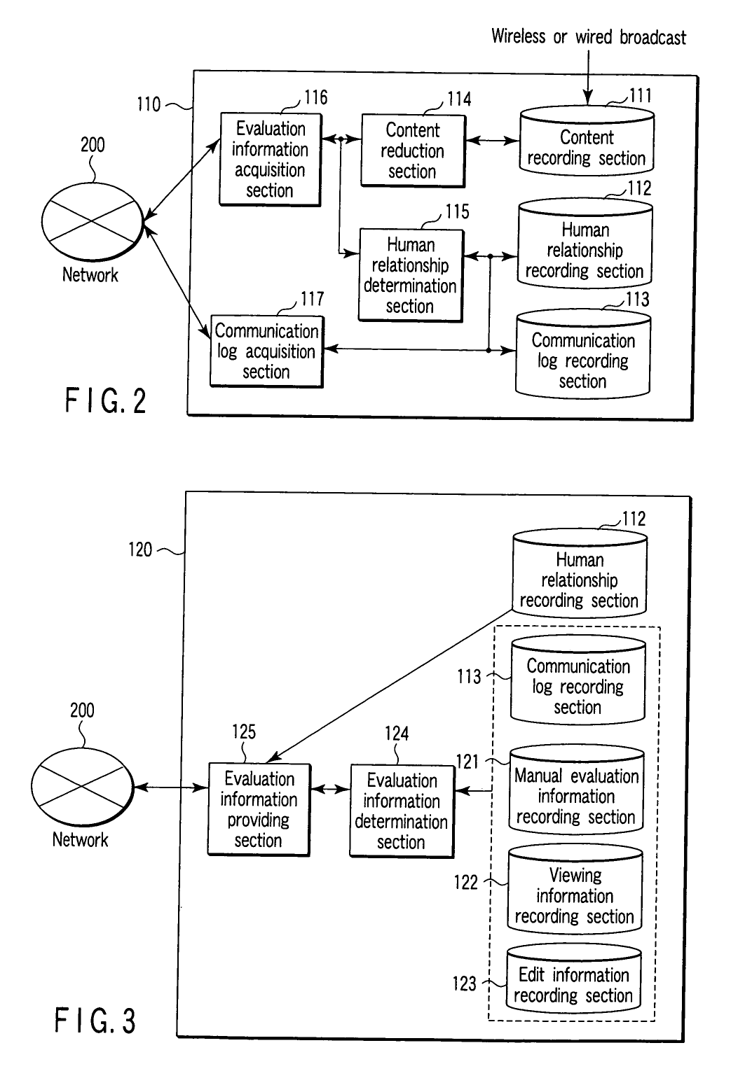

As described above, a configuration according to an embodiment of the present invention is roughly divided into two portions, i.e., a content reduction portion which queries evaluation information on contents and carries out reduction of recording contents in accordance with the contents of the information; and a content evaluation portion which responds to query. With respect to query, each section described in FIG. 1 may exist in a same system or may exist in another system connected with communication means including a network. FIG. 2 to FIG. 5 are views each showing an example in which only partial functional constituent elements are provided from among the configuration shown in FIG. 1. In FIG. 2 to FIG. 5, like constituent elements in FIG. 1 are designated by like reference numerals. A detailed description is not repeated here. There is no need for respective viewing terminals or the like to provide the configurations shown in FIG. 1 and FIG. 2 to FIG. 5 as their independent constituent elements. For example, the viewing terminals may provide only a communication facility and only a constituent element required for viewing by intensively carrying out image recording and management at one site.

FIG. 2 is a diagram showing an example of a system configured by sampling a content reduction portion 110 (hereinafter, referred to as a “second configuration”), for example. FIG. 3 is a diagram showing an example of a system configured by sampling a content evaluation portion 120 (hereinafter, referred to as a “third configuration”).

A content reduction section 114 in the second configuration 110 cannot provide feedback to a manual evaluation information recording section 213, a viewing information recording section 214, and an edit information recording section 215 as compared with the first configuration 100. Therefore, a second configuration 110 is inferior to the first configuration 110 in level at which the invention can be carried out. A functionally limited content recording apparatus, for example, can be assumed as the second configuration 110.

In addition, a third configuration 120 assumes an individual use personal computer or the like which carries out a recording or editing operation of contents, although there is no need for automating reduction, for example.

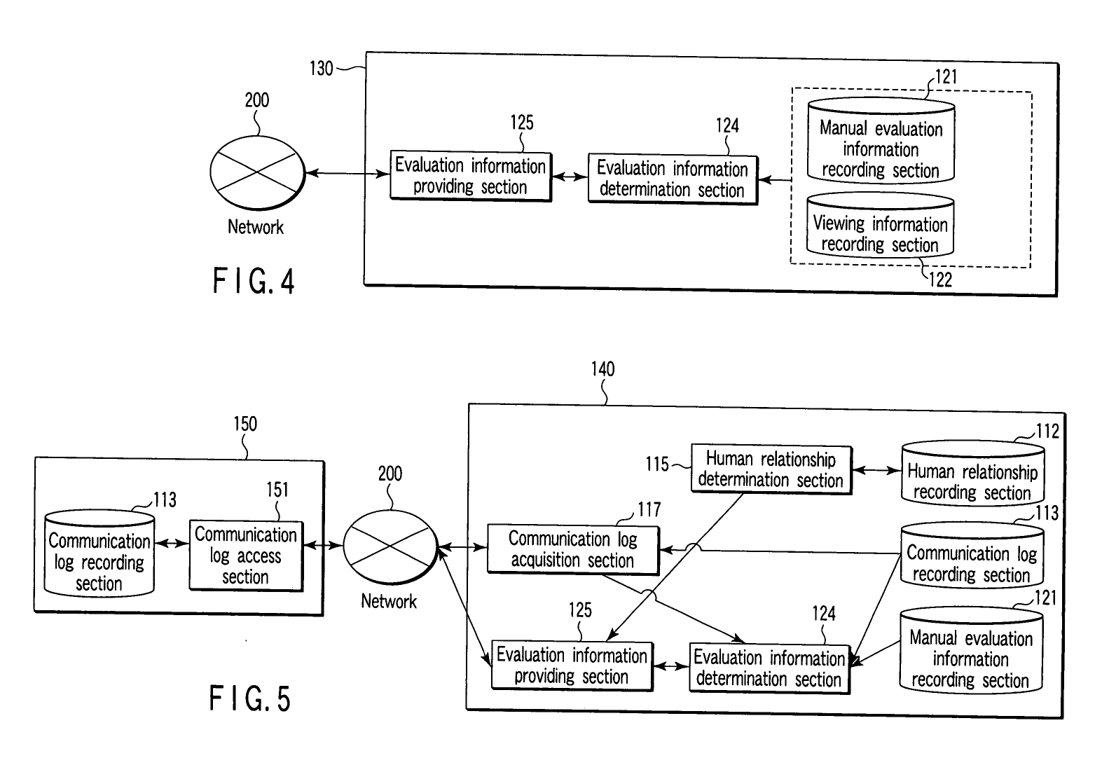

FIG. 4 is a diagram showing a fourth configuration 130 which is a simplified configuration intended to further functionally limit the content evaluation portion shown in FIG. 3 and collect evaluation information by a plurality of persons. The fourth configuration 130 eliminates a human relationship recording section 112, a communication log recording section 113, and an edit information recording section 123 in the third configuration 120.

FIG. 5 is a diagram showing a fifth configuration 140 for carrying out discussion relating to contents by adding the evaluation information regarding the contents to the fourth configuration 130 and a sixth configuration 150 having only a communication server such as chat service or bulletin service and E-mail service which generally exists over a network. Specifically, in the fifth configuration 140, in addition to the fourth configuration 130, includes a human relationship recording section 112, a communication log recording section 113, a human relationship determination section 115, and a communication log acquisition section 117, but is not equipped with a viewing information recording section 122. A discussion relating to contents can be made by providing means for acquiring and recording such a communication log. In addition, although the sixth configuration 160 includes only a communication log recording section 113 and a communication log access section 151, such a configuration can be regarded as a part of the configuration according to the embodiments of the present invention.

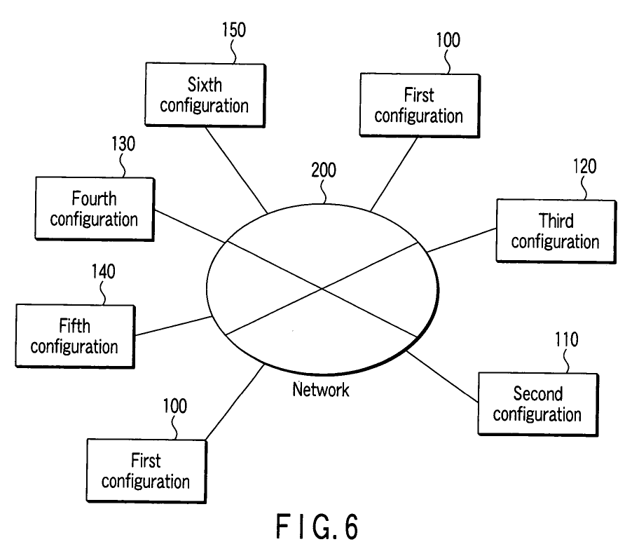

FIG. 6 is a diagram showing a whole configuration in which the above configurations have been connected to each other via a network.

As shown in FIG. 6, the first configuration 100 to the sixth configuration 150 each are connected to a communicable network 200. Each system is configured such that another system has any accessible address and can exchange data in accordance with an existing method. In this case, for example, in the Internet, an address is provided as an IP address, and an HTTP protocol or an SMTP protocol may be utilized for a data exchange system. In the case of the Internet, although a case in which an access limit node such as a firewall (FW) is interposed and direct communication cannot be made is presumed, data exchange may be indirectly carried out in accordance with a publicly known method such as NAT or tunneling. Asynchronous, indirect access means such as SMTP protocol can also function efficiently. It is also possible to presume a method of allocating an access path using a relay host or virtual networking using a virtual private network (VPN).

In the above described network, with a configuration having one or more content reduction means and a configuration having one or more content evaluation providing means, if a plurality of users exist, a system according to the present invention can be operated over the above described network.

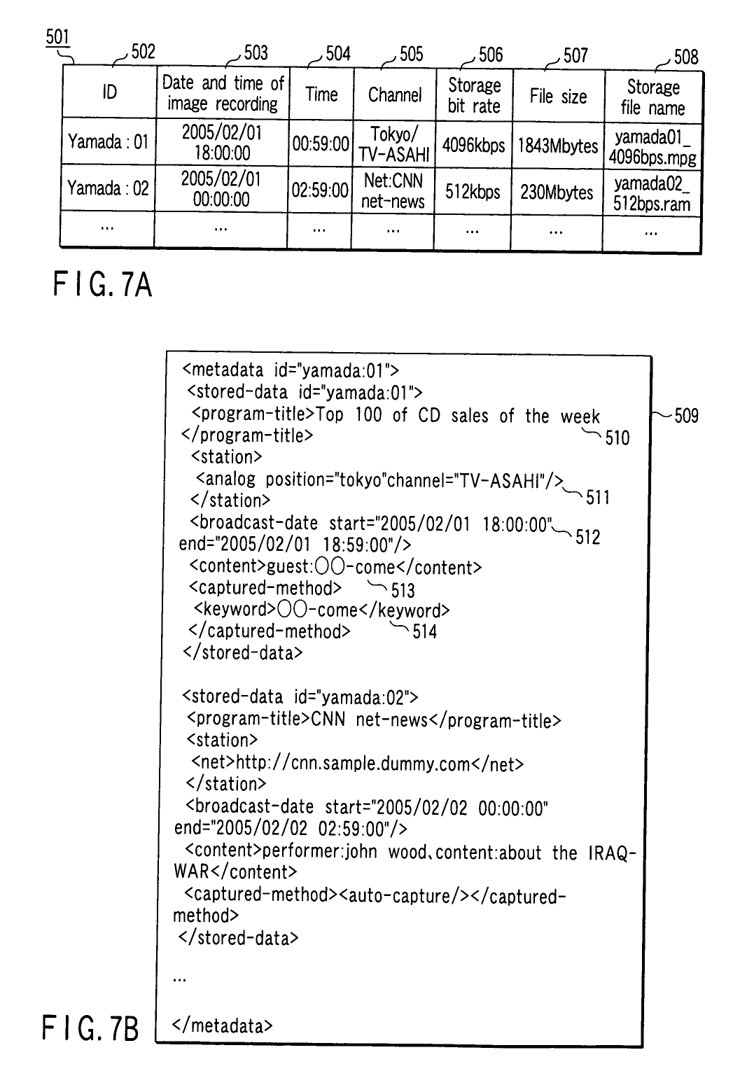

FIG. 7A and FIG. 7B are views showing an example of a data structure of content recording information recorded in a content recording section 111.

Recording contents is not described in detail because it is not a subject of the present invention. However, it is possible to carry out image recording of a television program by using a publicly known technique. Basic meta data including a program title or brief information can be easily obtained from data providing service including EPG/i-EPG.

A content recording table 501 shown in FIG. 7A includes a content ID 502, a date and time of image recording 503, an image recording time 504, an image recording channel 505, a storage bit rate 506, a final size 507, and a storage file name 508. If a worldwide or nationally unique ID can be obtained, they can be used as the content ID. If such an ID cannot be obtained, an internally unique ID within a system is issued every time recording is carried out. In this example, ID called yamada: 01 is assigned because it is the first content recorded by a user “yamada”. The image recording channel 505 records streaming data streamed over a network in addition to a general TV broadcast. In addition, there are many cases in which meta data such as a title or a performer can be obtained with respect to respective contents, and thus, these items of the meta data are recorded together. Meta data 509 shown in FIG. 7B indicates an example of meta data relevant to yamada: 01. The meta data has a program title 510, channel information 511, a date and time of broadcast-date 512, introduction to contents 513, and an image recording keyword 514.

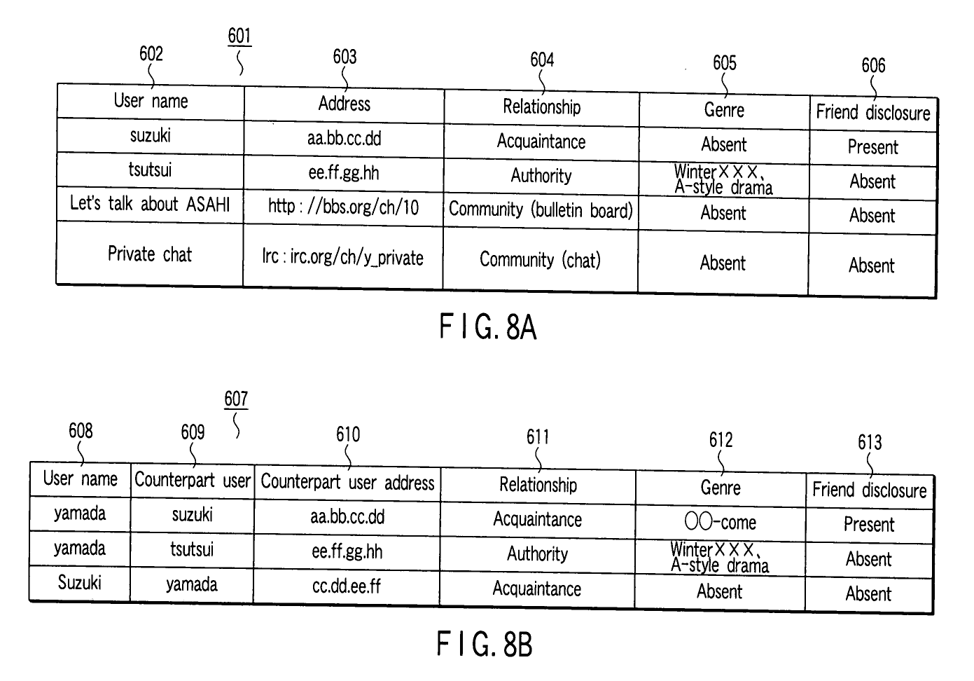

FIG. 8A and FIG. 8B are views showing an example of a data structure of human relationship information recorded in the human relationship recording section 112.

A human relationship table 601 shown in FIG. 8A has a counterpart user name 602, a counterpart system address 603, a human relationship 604, a query genre 605, and a friend relationship disclosure 606.

The human relationship 604 enables settings of variations such as acquaintance, friend (mutual acquaintance); authority (having one-sided acquaintance), network community (bulletin board: unspecified number or unknown acquaintance), network community (chat service: mutual acquaintance and majority). The acquaintance may include a friend relationship in addition to a mere acquaintance. In addition, the authority denotes a person having abundant knowledge about a certain genre. The authority primarily is different from other relationship in that it relates to importance of fiend disclosure information or content evaluation value, and network community; and the network community is different from another relationship in that evaluation information is obtained via communication log acquisition means.

A human relationship table 607 shown in FIG. 8B shows an example of a data structure in the case where a plurality of users record information on the same system in the fourth configuration 130 or the fifth configuration 140. In addition to the human relationship table 601, a specific user 609 exists.

In FIG. 8A and FIG. 8B, the fields of the same name have the same meanings.

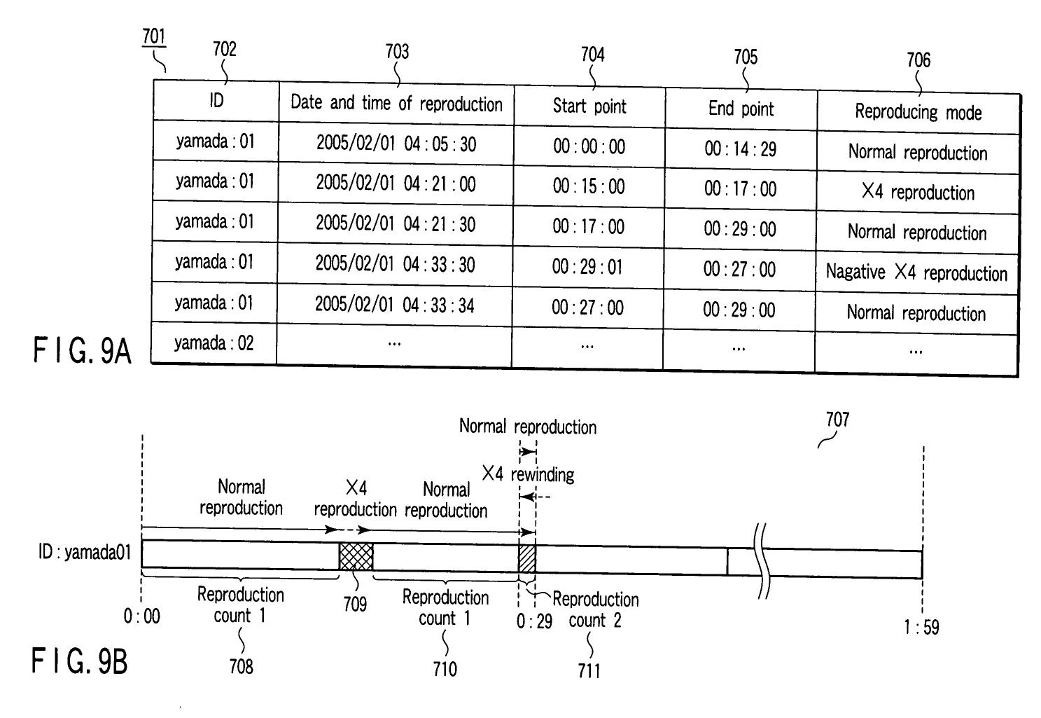

FIG. 9A and FIG. 9B are views showing an example of a data structure of viewing information on contents recorded in a viewing information recording section 122.

A viewing information table 701 shown in FIG. 9A has a content ID 702, a date and time of reproduction 703, a start point 704, an end point 705, and a reproducing mode 706. The content ID 702 is provided as an ID of viewed contents. As a principle, although the ID-exists in the content recording table 501, in the case where deletion is executed, such an ID does not exist occasionally. The date and time of reproduction 703 is the date and time when the content is recorded. The start point 704 and the end point 705 are provided as intervals at which the contents have been reproduced. The start point and end point are recorded at a relative time interval from the beginning of contents.

A reproducing mode 706 records what type of viewing the viewing is. In this example, there are three types of reproduction, i.e., normal reproduction, ×4 (4-time) reproduction, and negative ×4 reproduction (rewinding). Another item of viewing information is recorded every time mode is changed.

In FIG. 9B, there is a view showing that the viewing information recorded in the viewing information table 701 is defined on a time axis, where each of the sections in one item of contents can be ranked by using the viewing information. For example, a ×4 reproduction portion 709 can be determined to be a portion at which a value is low for a user compared to normal reproduction portions 708 and 710. In contrast, a portion 711 at which reproduction has been carried out once again after ×4 rewinding can be determined as a portion at which a value is high for a user.

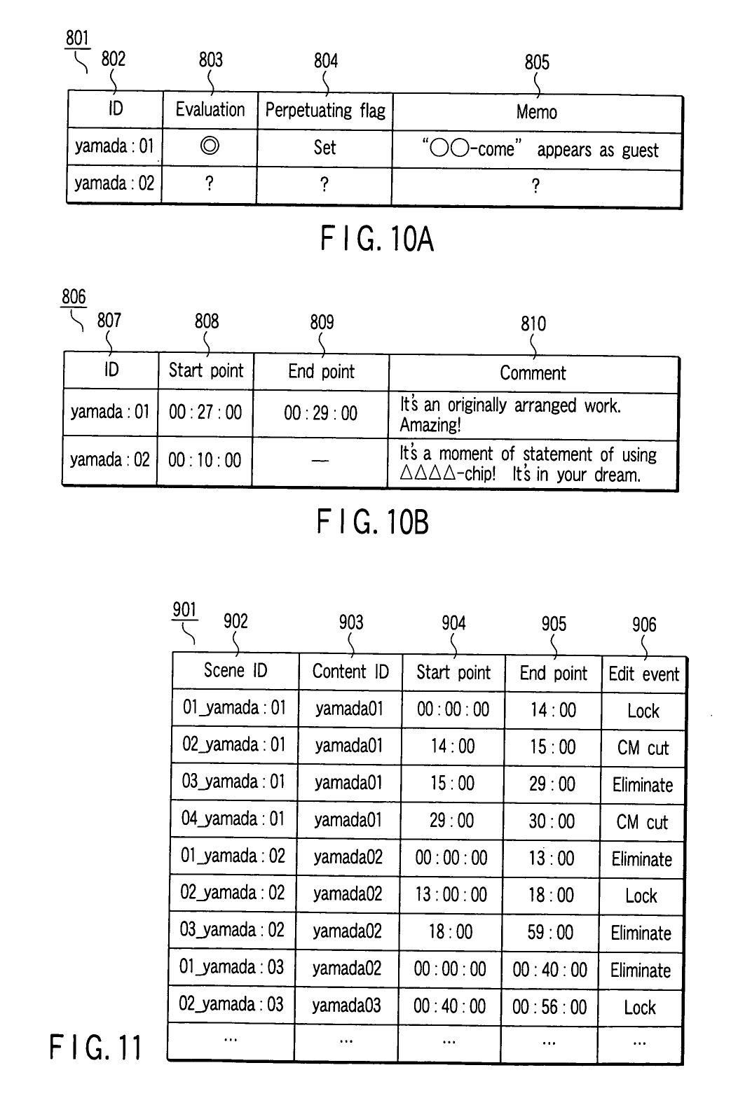

FIG. 10A and FIG. 10B are views showing an example of a data structure of evaluation information on contents recorded in a manual evaluation information recording section 121.

A manual evaluation information table 801 shown in FIG. 10A has a content ID 802, an evaluation 803, a perpetuating flag 804, and a memo 805.

The content ID 802 is provided as an ID of evaluated contents. As a principle, although the ID exists in the content recording table 501, in the case where deletion is carried out, such an ID does not exist occasionally. The evaluation 803 indicates an evaluation of contents. For example, evaluation can be carried out at three levels of “NG”, “Good”, and “Excellent”. The perpetuating flag 804 is provided as a flag denoting whether the contents are out of the subject of deletion. In the case where there is a reason, for instance, that the contents are very favorite, the user can instruct the apparatus to handle the contents to be out of the subject of deletion, by setting this flag. The memo 805 is provided as a memo relating to evaluation of the contents. When evaluation information is disclosed to another user, a greater amount of information can be transmitted to a counterpart user by describing a reason for the evaluation or the like.

A scene comment information table 806 shown in FIG. 10B is provided as another example of manual evaluation information and is also provided as an example of a data structure in the case where evaluation information is provided to each of the sections in contents in the form of comment. The scene comment information table 806 has a content ID 807, a start point 808, an end point 809, and a comment 810. The content ID 807 is similar to the content ID 802. The start point 808 and the end point 809 are provided as information for specifying a target portion of target contents for providing comments. In the case where no end point exists, it denotes being a comment relevant to the start point itself. A comment relevant to a predetermined number of seconds before and after the start point may be provided as a variation. A comment 810 records the content of a comment.

The above described manual evaluation information table 801 and scene comment information table 806 are not exclusive, and both of them can be used at the same time.

These items of table information are provided as basic data for requesting evaluation relating to the user's contents together with the contents of the viewing information table 701.

FIG. 11 is a view showing an example of a data structure of edit information on contents recorded in an edit information recording section 123.

An edit information table 901 has a scene ID 901, a content ID 903, a start point 904, an end point 905, and an edit event 906.

The edit portion is indicated in the range of the start point 904 and the end point 905 of contents indicated by the content ID 903. A scene ID 902 is assigned to a “scene”. The edit event 906 indicates the content of a processing operation executed for a scene. In this example, there are a storage processing operation “lock”, a CM deletion processing operation “CM cut”, and a pending processing operation “eliminate”.

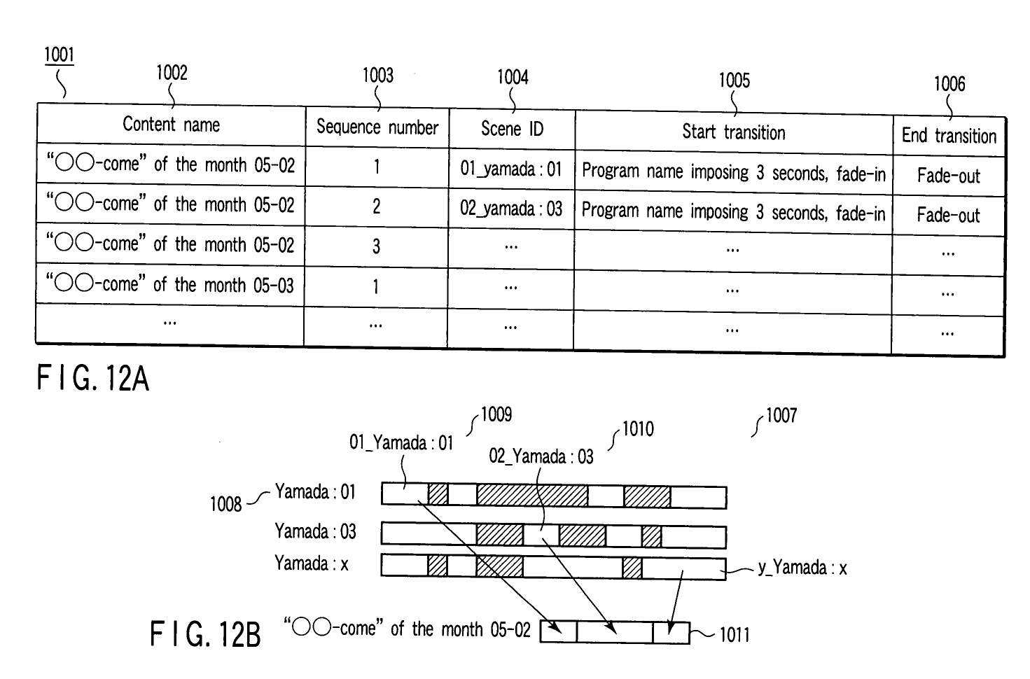

FIG. 12A and FIG. 12B are views showing an example of a data structure of edit information on contents recorded in an edit information recording section 123, in particular, registration information on “processed contents” provided as one item of contents by connecting portions from a variety of contents. For example, the recording section records the content of an action of picking up only a batting of a specific player from among a plurality of professional baseball broadcast contents, and then, producing processed contents called “a list of at-bats of player A”. A processed content edit table 1001 shown in FIG. 12A has a content name 1002, a sequence number 1003, a scene ID 1004, a start transition 1005, and an end transition 1006. The content name 1002 is a name of processed contents and is an identifier. A scene and a sequence to be used is defined by a pair of sequence number 1003 and scene ID 1004. The start transition 1005 and the end transition 1006 are screen effects to be applied at the time of starting and ending a scene. In the example of “a list of at-bats of player A” described previously, the recording section records an edit effect such as introducing the name of game before each at-bat (three seconds of program name imposing), fade-in, and fade-out at the end of the batting.

In FIG. 12B, there is a view showing a relationship between data recorded in a processed content edit table in an understandable manner. FIG. 12B shows specific scenes (1009 and 1010) of which each of the contents 1008 are arranged to configure new processed contents 1011. Live data on processed contents used here is provided regardless of whether or not an entity of each scene is copied or is configured from only a reference. In the case where a transition becomes complicated or in the case where there is a sufficient space, it seems that copying operation is made. However, in the case of contents whose copying is limited, a processing operation of configuring only reference information and applying transition in real time during reproduction is presumed. It is sufficient to grasp at least a use state of each scene, for example, which processed contents are used or how many times the processed contents are used.

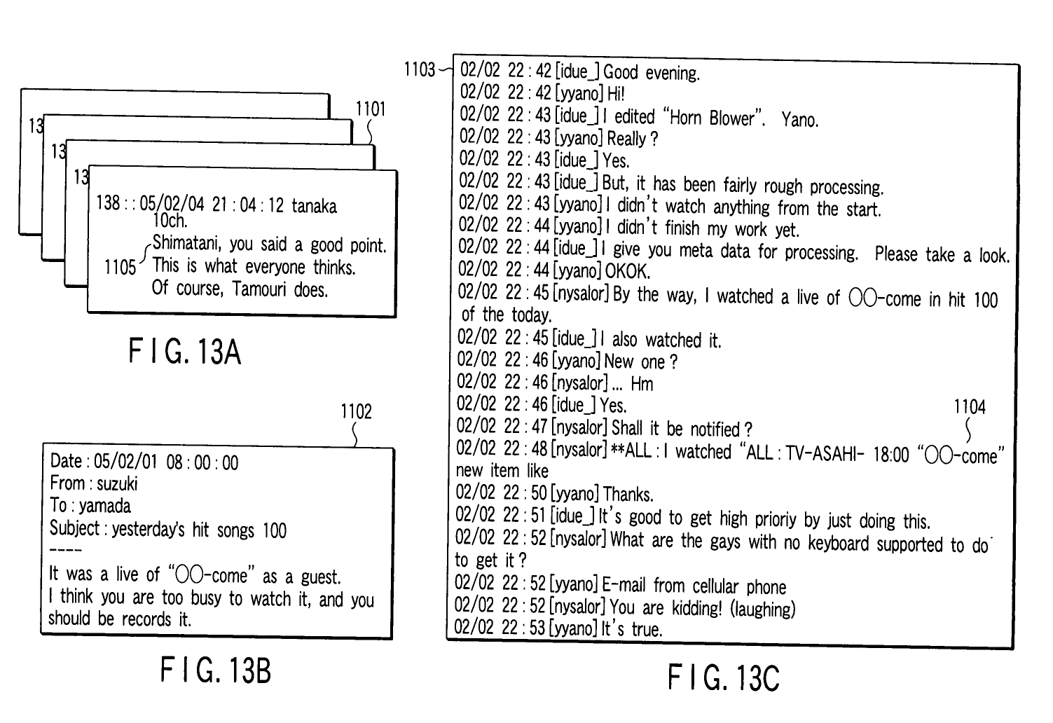

FIG. 13A, FIG. 13B and FIG. 13C are views showing an example of a data structure of a communication log, namely, conversation information recorded in a communication log recording section 113. FIG. 13A, FIG. 13B, and FIG. 13C show an example of message 110 on a electronic bulletin board on a Web site (refer to FIG. 13A); an E-mail submission 1102 on a inter-friend or community mailing list (refer to FIG. 13B); or a chat statement 1103 using IRC or IM (refer to FIG. 13C). Among a communication log, information on contents which seems to be important for a communication party is described, whereby a mark may be provided to the contents. By this marking, evaluation is carried out on part or all of the contents. The evaluation information can be used as a viewing recommendation or an evaluation criterion referred at the time of deleting contents. There are two marking methods for example: a method 104 for describing content information in a predetermine format and a method 1105 for determining a positive statement and contents corresponding thereto by using a publicly known natural language processing technique.

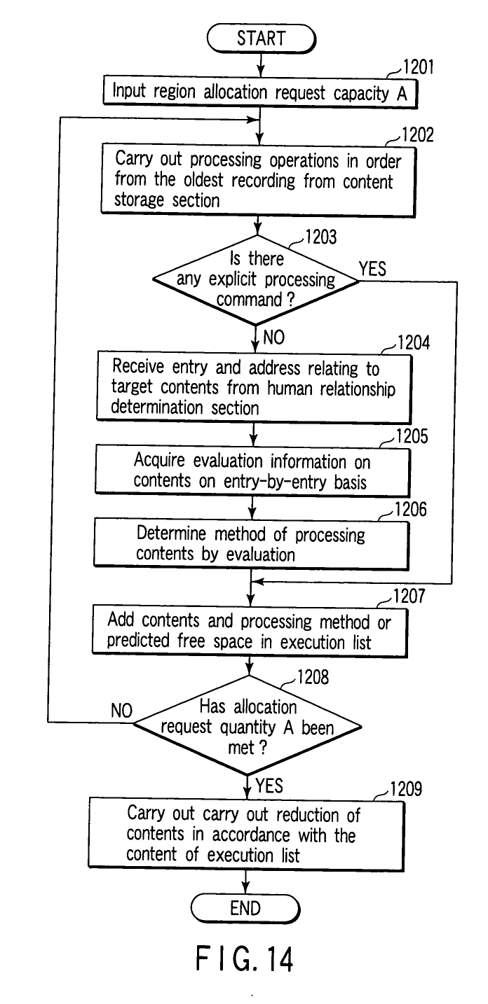

FIG. 14 is a flow chart showing an example of a processing outline of reduction contents.

First, a request for allocating a region of size A is issued to a content reduction section 114 (1201). This region allocating request is issued from a recorder main body by utilizing publicly known methods, in general, when image recording of new contents has been schedule or when a user attempts to allocate a space for any purpose and the like. In the case where packaging is carried out in a system requiring a large amount of processing time, such packaging can include a variation of starting processing at a time interval at which another item of contents to be processed does not exist. First, a sequence of contents to be processed is determined. In this example, the contents are determined in order of date and time of recording (1202). Another example can include the order of the contents being viewed. Next, it is checked whether or not data on target contents exist in an explicit processing command, for example, an explicit deletion command or in an edit information table 901 (1203). In the case where the data has existed, a scene that can be deleted (“CM cut” “Eliminate”) is added in an execution list (1207). Next, evaluation information on target contents is acquired. As evaluation information, in addition to one's own evaluation information recorded in a manual evaluation information recording section, an evaluation query destination entry and an address relevant to target contents are acquired from a human relationship determination section 115 (1204). The evaluation information on target contents is acquired with respect to each of the obtained query destinations (1205). In the case where acquisition requires a large amount of time, although an acquisition result may be cached, more advantageous effect is attained if the evaluation information is closer to a time immediately before deletion; therefore, it is preferable that an update check be periodically made. A content processing method is determined depending on each of the obtained evaluation values (1206). If evaluation is low or does not exist, it is possible to consider full deletion. If evaluation exists partially, it is possible to consider deletion of a portion other than such an evaluated portion, or alternatively, space reduction due to degradation compression and the like. These processed contents are added in an execution list (1207), and it is determined whether or not the whole processing operations registered in the execution list are sufficient to secure size A. If they are insufficient, next contents are processed. In the case where they are sufficient, a processing operation is executed in accordance with the contents of the execution list (1209). In the case where it is impossible to secure size A, there is a variation of determining a deletion target from a determination that one visits his/her friend's home and views the contents in the worst case, based on idea that the contents highly evaluated by one's friend are hardly deleted. In such a case, a deletion condition is notified to a user. If possible, it is desirable that the fact be notified to one's friend who has become an evaluation acquisition destination. Notification to one's friend can include automatic issuance of E-mail.

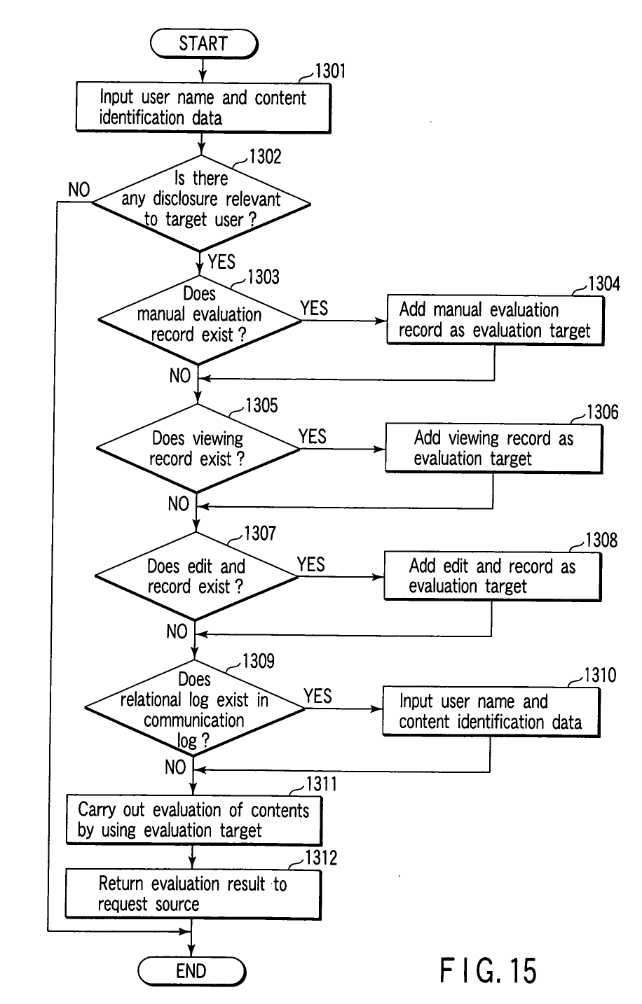

FIG. 15 shows an example of a basic flow chart of evaluating contents. Content evaluation is carried out when an access is provided to one's evaluation information providing section 125 via an evaluation information acquisition section 116 when one's contents are reduced, or alternatively, when another person reduces contents. In the case where processing requires a large amount of time, an evaluation processing operation is periodically executed so that the result may be cached.

When carrying out evaluation, a user name queried as an input and content identification data are received. In the case where one's own evaluation information is obtained, a user name is expressed by “self” or the like. The content identification data is provided as data for identifying contents. In the case where a worldwide unique content ID is assigned, that ID becomes the content identification data. In the case where no content ID is assigned, meta data on contents becomes the substitute. A system acquires one's own managed content ID which corresponds to content identification data. Next, it is determined whether or not evaluation information is disclosed to a requesting user (1302). In the case where the information is not disclosed, such a request is discarded, and a processing operation is terminated. The determination of disclosure is made by a human relationship determination section. There is a possibility that some of the contents are disclosed and some are not even by the same user. In the case where the user name is “self”, it is determined that the contents are disclosed unconditionally.

Now, a flow of determining an evaluation will be described here. An evaluation is determined from four items of manual evaluation recording data (1303), viewing recording data (1305), edit recording data (1307), and relational data contained in a communication log (1309). The communication log may exist in another host. In this case, the log is obtained via the communication log acquisition section 117. In the case where a large amount of time is required, the contents may be periodically cached. From among items of data, an evaluation is carried out by using one or more items relating to target contents (1303 to 1311). Then, its evaluation result is returned to a request source (1312).

An evaluation value is represented by numeric values relevant to all and part of the contents. The manual evaluation recording data is mapped in its substantially original form. Providing a comment is considered as providing a predetermined evaluation. Thus, that portion may be particularly highly evaluated, for example.

The viewing recording data is highly evaluated at an interval (711) at which the reproduction count is high or is lowly evaluated at a portion (709) at which fast feeding has been carried out. Edit information recording data is highly evaluated at a portion at which an edit event is “lock” or is particularly highly evaluated in a scene (1009 or 1010) which has been captured as part of the processed contents. With respect to the relational data contained in a communication log, the contents which have been taken as a topic or a portion of the contents (1104 or 1105) are particularly high. A total of these values or vector data for each evaluation criterion is defined as an evaluation value.

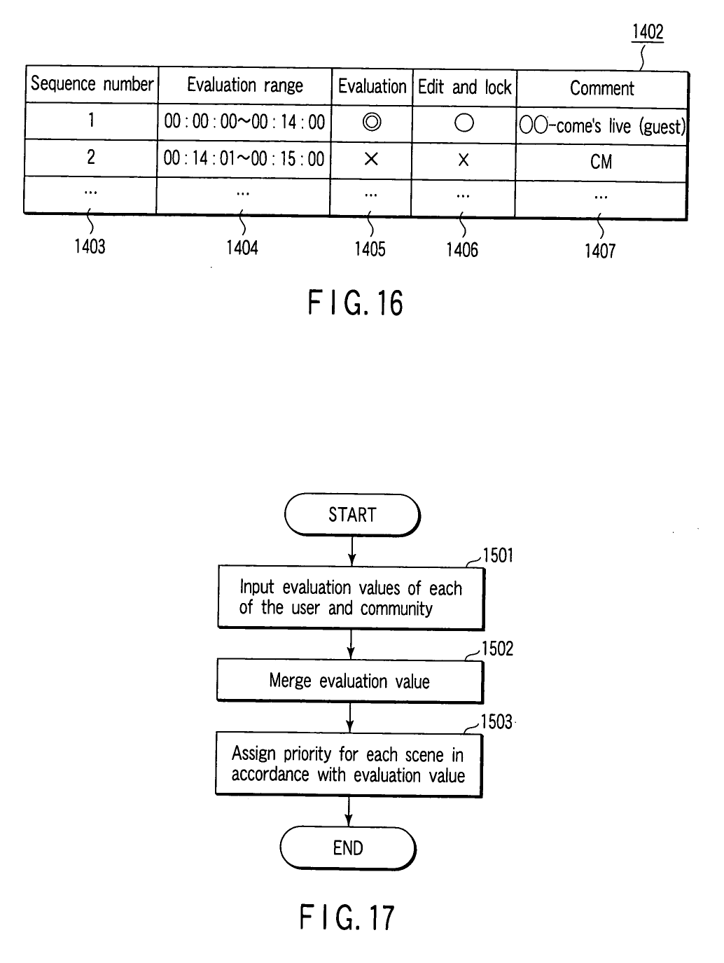

FIG. 16 is a view showing an example of data on an evaluation result. The data has a content name 1401 and a scene evaluation table 1402. The scene evaluation table 1402 consists of a sequence number 1403, an evaluation range 1404, an evaluation 1405, an edit lock 1406, and a comment 1407.

The content name used here is provided as a content name which corresponds to queried content identification data. The sequence number 1403 and the evaluation range 1404 each represent an evaluation range included in specific contents. The evaluation 1405 is provided as an evaluation value; the edit lock 1406 indicates whether or not a lock having presumed acquisition of processed contents is instructed; and the comment 1407 is provided as a comment recorded in data targeted for evaluation.

FIG. 17 is a flow chart showing an example of a reduction method which the content reduction section 114 carried out upon the receipt of these evaluation values.

As an input, evaluation values from a variety of users and/or communities are input, the evaluation values having been obtained by the evaluation information acquisition section 116 (1501). These evaluation values are merged (1502). The merging method includes: adding all the evaluation values or adding evaluation values on a scene-by-scene basis or on an interval-by-interval basis. In addition, in accordance with a human relationship, a weight may be applied at the time of an adding operation. Then, according to the result, a priority is assigned on a scene-by-scene basis, and a reduction method is determined (1503). In this case, the content reduction section 114 may present a user with viewing priority contents (or scene) in the case where the contents targeted for reduction is evaluated to be higher than a predetermined value in addition to reduction contents (i.e., deletion or compression).

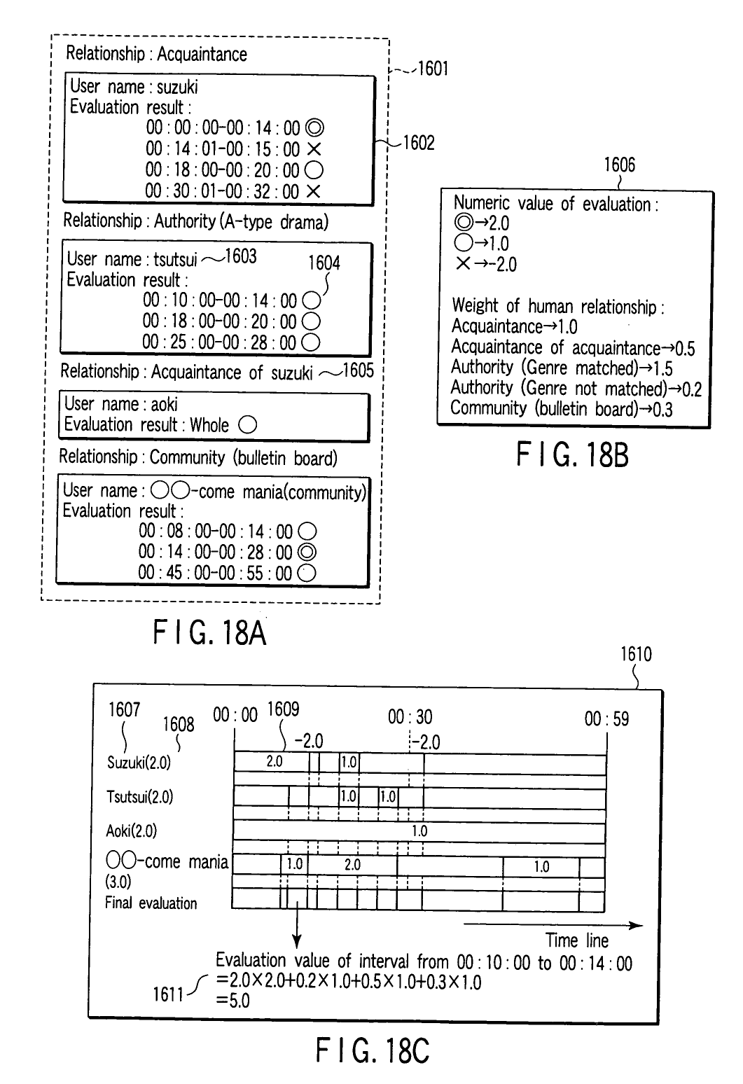

FIG. 18A, FIG. 18B, and FIG. 18C are views showing an example of a method of computing an evaluation value at each interval at which a weight for an adding operation has been changed.

In FIG. 18A, there is shown an evaluation value being an input. An acquired user unit (1602) includes a user name (1603) and whole or partial evaluation (1604). In addition, a human relationship between a user who has carried out evaluation and a user who attempts to carry out reduction of contents is obtained from a human relationship acquisition section (1605). As a human relationship, it is possible to consider handing of indirect information such as acquaintance of acquaintance in addition to the acquaintance, authority, and community recorded in the human relationship table 601. With respect to the information, in addition to a method for a user to explicitly recording the information, querying to directory service such as an explicitly specified directory management host, or alternatively, querying to a human relationship determination section which exists in an acquaintance's address, in the case of a communication server mode such as the fifth configuration 140, such information can be easily acquired because a human relationship of a user who uses that server can be grasped. With respect to such evaluation values and a human relationship, numeric conversion as shown in FIG. 18B and FIG. 18C is carried out, and an evaluation value is computed on an interval-by-interval basis. As one of the computing methods, the evaluation values of each user at an interval to be acquired are summed after applying a weight of a human relationship (1611). For example, in the case where the evaluation values shown in FIG. 18A has been subjected to conversion shown in FIG. 18B and FIG. 18C, the evaluation value at an interval of 00:10:00 to 00:14:00 is 5.0. The evaluation values are computed with respect to all the intervals of contents, and a reduction method is determined on the evaluation value-by-value basis. The simplest determination method includes determining and applying a threshold value on a reduction method-by-method basis, for example, so that a portion whose evaluation value is smaller than 0 is deleted, to a portion whose evaluation value is equal to or smaller than 1, degradation compression is made, or an evaluation value 2 or more is left as it is.

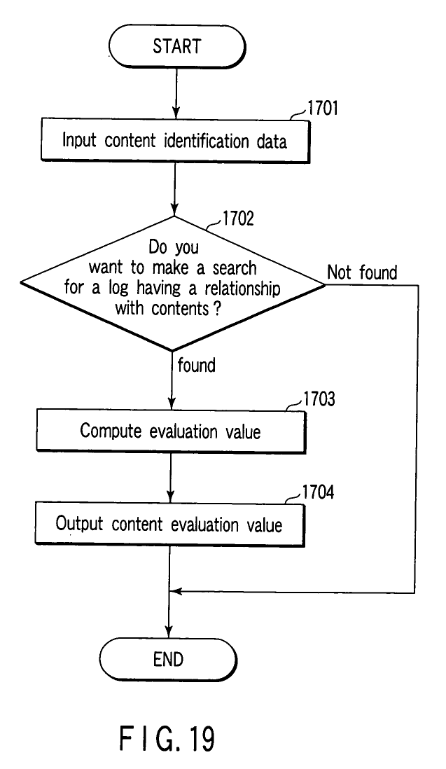

FIG. 19 shows an example of a flow of a processing operation for analyzing a communication log obtained by the communication log acquisition section 117 and acquiring an evaluation value of target contents.

The processing operation is carried out at the evaluation information determination section 124. After receiving content identification data as an input, the corresponding content ID is acquired, and a search is made for a communication log having a relationship with contents by using the associated meta data. The simplest method can include: searching for a log in which a program name and a date and time of broadcast have been described (1701 to 1702). It is possible to consider that precision is increased by carrying out publicly known synonym detection or by using an abbreviation. If the communication log has been found, it is determined whether that log carried out a positive evaluation or a negative evaluation (1703 to 1704). This determination can be made by using a simple pattern match for a character string such as “no good” or “great” or using a publicly known natural language processing technique. In the case where a communication log is a chat such as IM or IRC, an evaluation of an interval as well as a whole evaluation can be acquired according to a log type, like an evaluation of a predetermined interval before and after the corresponding log. In addition, like a statement 1104 based on a predetermined format, evaluation information may be easily provided by issuing a statement in a format recognized by an evaluation information determination section.

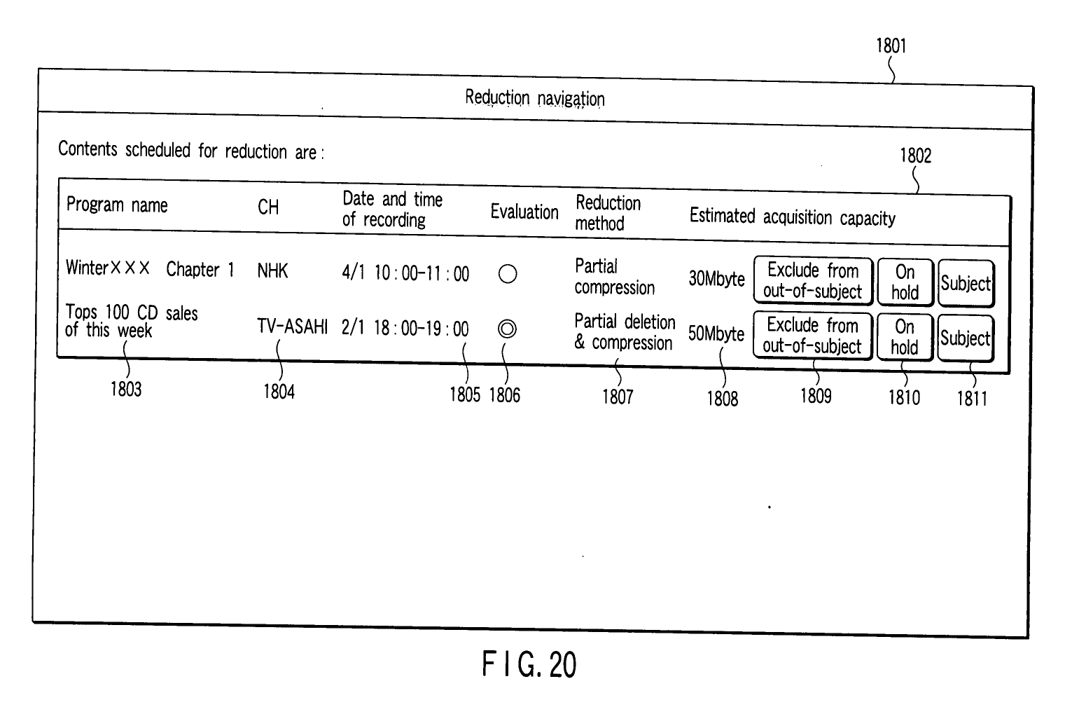

FIG. 20 shows an example of information display screen when a user has provided an access to the information contained in the content reduction section 114.

The screen 1801 displays a dialog presented with information on contents targeted for reduction (1802 to 1806). This screen also displays specifically what reduction is carried out (1807) or how large a predicted free space is provided (1808) altogether. In the case where the display does not meet the user's expectation, a request for “removing from reduction targets” or “pending” can be issued” (1809 to 1810). The former sets a perpetuating flag to “present” with respect to the content manual evaluation information table 801. The contents having the perpetuating flag set thereto return the highest point as a manual evaluation value. The latter is eliminated from a set of contents targeted for reduction during a predetermined period of time. When a “detail” (1811) is selected, the specific reduction contents, in particular, a reduction method on an interval-by-interval basis, is presented.

According to the present invention, there can be avoided a circumstance that a user accidentally deletes contents having been recorded as an image in view of an element which will be introduced later, making it impossible to catch up with a topic of the contents.

As a result, very interesting contents can be viewed from among the contents recorded in tremendous amount, and a loss of communication opportunities can be reduced. In addition, a value of effective contents is widely accepted, and finally, re-energization of the whole content providers can be expected.

Additional advantages and modifications will readily occur to those skilled in the art. Therefore, the present invention in its broader aspects is not limited to the specific details, representative devices, and illustrated examples shown and described herein. Accordingly, various modifications may be made without departing from the spirit or scope of the general inventive concept as defined by the appended claims and their equivalents.

What is claimed is:

1. A content management system for managing contents in association with content information, the contents including at least one of a video image and an audio, which are received from a network or a broadcast including a wired or wireless connection and are stored in a storage device, comprising:
a human relationship table which records information relating to a plurality of entries utilizing the content management system;
entry searching means for searching one of the plurality of entries as a query destination of an evaluation relevant to designated contents stored in the storage device, using the human relationship table;
content evaluation information acquisition means for acquiring evaluation information from the query destination with respect to the designated contents; and
content reduction means for reducing the designated contents based on the evaluation information.

2. A content management system according to claim 1, further comprising:
meta data management means for assigning and managing meta data with respect to the recorded contents; and
content evaluation means for computing evaluation information in accordance with a predetermined method from information managed by the meta data management means with respect to a content evaluation information query from another person, and then, returning a response to the query.

3. A content management system according to claim 1, wherein each of the means is alternately connected via a network.

4. A content management system according to claim 1, wherein the entry searching means accepts as an input, meta data such as a content title, a genre, content, or a related character, and determines a query destination from an acquaintance registered in advance and an authority registered on a keyword-by-keyword basis relating to contents, based on the meta data.

5. A content management system according to claim 2, wherein the content evaluation means carries out an evaluation by using at least one or more items of information from among evaluation information which an evaluator has explicitly added to contents, reservation information based on the means utilized in recording the contents, viewing information based on a count of whole or partial viewing of the contents, and deletion or edit information on the contents.

6. A content management system according to claim 1, wherein the content reduction means executes any of deleting contents, carrying out non-reversible compression, leaving as it is until next determination has been made, based on evaluation information obtained from the content evaluation acquisition means.

7. A content management system according to claim 6, wherein, in the case where the evaluation information includes viewing information or edit information, making it possible to acquire that a part of contents is highly or lowly evaluated, partial deletion or partial compression is carried out with respect to such a part of the contents.

8. A content management system according to claims 1, further comprising:
communication log acquisition means for acquiring communication log information which exists in a system or over a network,
wherein the entry searching means adds as a candidate of a query destination a network community having at least one or more log acquisition methods to which the communication log acquisition means can be accessed, the log acquisition method being explicitly registered in addition to a target entry registered on a specific entry-by-entry basis or on a keyword-by-keyword basis, and
the content evaluation information acquisition means has means for obtaining an evaluation of contents specified in accordance with a predetermined method from the communication log information.

9. A content management system according to claim 4, further comprising:
human relationship providing means for providing human relationship information associated with at least one of the acquaintance and authority,
wherein the human relationship acquisition means acquires human information associated with at least one of the acquaintance and authority based on the human relationship information recorded in the human relationship providing means.

10. A content management system according to claim 8, further comprising:
human relationship providing means for providing human relationship information associated with at least one of the acquaintance and authority,
wherein the human relationship acquisition means acquires human information associated with at least one of the acquaintance and authority based on the human relationship information recorded in the human relationship providing means.

11. A content management system according to claim 1, wherein the content management means presents a user with viewing priority contents in the case where an evaluation of contents targeted for reduction is higher than a predetermined value.

12. A content management system according to claim 6, further comprising a manual evaluation information recording means for, when reducing other than pending is carried out by the content reduction means, recording evaluation information relating to target contents in predetermined contents.

13. A content management system for managing contents including at least one of a video image and an audio, which are received from a network or a broadcast including a wired or wireless connection and are stored in a storage device for storing the received contents in association with content information, comprising:
a human relationship table which records information relating to a plurality of entries utilizing the content management system;
an entry searching section which searches one of the plurality of entries as a query destination of an evaluation relevant to designated contents stored in the storage device, using the human relationship table;
a content evaluation information acquisition section which acquires evaluation information from the query destination with respect to the designated contents; and
a content reduction section s which determines a method of reducing the designated contents based on the evaluation information.

14. A method of managing contents including at least one of a video image and an audio, which are received from a network or a broadcast including a wired or wireless connection and are stored in a storage device for storing the received contents in association with content information, comprising:
storing information relating to a plurality of entries;
searching one of the plurality of entries as a query destination of an evaluation relevant to designated contents stored in the storage device, using the plurality of entries;
acquiring evaluation information from the query destination with respect to the designated contents; and
determining a method of reducing the designated contents based on the evaluation information.
